(19) United States
(12) Patent Application Publication
(10) Pub. No.: US 2026/0284616 A1
(43) Pub. Date: Sep. 24, 2026

(54) MIXER FOR DISSOLVING TABLETS

(71) Applicant: Pontus RANDVER, Virserum (SE)

(72) Inventor: Pontus RANDVER, Virserum (SE)

(21) Appl. No.: 18/868,594

(22) PCT Filed: May 22, 2023
(86) PCT No.: PCT/SE2023/050501

§ 371 Date: Nov. 22, 2024

(30) Foreign Application Priority Data
May 23, 2022 (SE) 2230159-2

(51) Int. Cl. B01F 35/214; B01F 21/00; B01F 35/50; B01F 101/48

(52) U.S. Cl. CPC B01F 35/214; B01F 21/501; B01F 35/514; B01F 2101/48

(57) ABSTRACT

A mixer for dissolving tablets (11) consists of; a metal body (1) fitted with a float housing (6) indicator housing (8) and a sight glass barrel (14); a control lever/knob for incoming fluid; a float (10) connected by an indicator (9) showing the consumption and dissolution of the tablet (11) which can be stopped by draining the mixer and thus saving the tablet which is contained within tablet containers (19) which can be fitted with suitable tablets (11) and loaded into the mixer for activation, removed for saving and sealed with a plug (21).

### TECHNICAL AREA

This invention relates to mixers in which a tablet, granulated product and other concentrated powder and capsules dissolve in water or other liquids flowing through the mixer or collecting in the mixer. The mixer also serves as a storage place for undissolved tablets once the water has been drained.

### BACKGROUND TO THE INVENTION

Plastic containers are widely used, for the transport and storage of various diluted chemical preparations. As a society we are moving away from acquiring various preparations such as detergents, fertilisers, insecticides, pesticides, polishes, etc. pre-diluted or concentrated poured into plastic packaging. Bottles, cans, tetrapaks etc. These packages are expensive to transport, heavy to carry, bulky to store, hold high embodied energy through their manufacture and are difficult to recycle. The societal aspirations for a more sustainable and environmentally friendly future will mean that we switch to tablets and other concentrates as well as powders, and we add our own water and liquids for appropriate dilution. Citations such as DE 3326249 the same as SE0132726T, SE 7811566-4, SE 7212121-3, show both tablets and containers, but they are intended for permanently installed machinery.

On the market there have long been tablets for dishes and washing machines, fertilizers for the lawn, all of which we have become accustomed to. Nowadays there are also tablets and other concentrates for most purposes, as well as in powder form with soluble packages, ampoules with concentrate for cleaning in households. These are also found in industry, agriculture, indoors and outdoors and for purification of liquids, however, these are largely dependent on plastic vessels for mixing with water that we draw from the kitchen tap or other water hydrant. The environment, water savings and the energy issues are high on the agenda, as we now transition to a more sustainable society with green energy and we install more sustainable technology, such as solar panels.

In order for these panels to maintain their efficiency and efficacy, they must be cleaned regularly. There are companies that take on such assignments like window cleaning, but the customer cannot possibly keep track of which preparations are used. As consumers become increasingly informed about new environmentally friendly products in tablet form, environmental thinking comes to the fore. Thus, they also want to be able to carry out their own maintenance work, with their own purchased preparations that are sustainable for the environment, as well as the right product for the job.

Maintenance and cleaning of vehicles and vessels is at best done at a car wash facility, marina, either automatically or do it yourself, which means that you buy tokens, get access to water and you use your own washing preparations, such as degreasing, detergent and wax. The associated containers (in the form of cans and bottles) are at best thrown into the bin or worst irresponsibly disposed of. The washing plant's filtration system should take care of the used liquids. The same applies to the transport sector, but usually at the haulage company, or on gravel planes as the vehicles are unwieldy to handle.

Maintenance of properties and their plots is carried out by the homeowner and is often done with a pressure washer, which is an energy-consuming and clumsy appliance to use, noisy and unwieldy to store. It is limited in terms of the height that it is effective for, and it is not easy to undertake any delicate work, as well as becoming difficult to perform any high-altitude work safely and with precision. Nowadays, lightweight equipment is available for elevated work, which is connected to a regular tank with a pump motor.

The containers with ready-mixed cleaning agent are available at the cleaning company or smaller backpack sprayer variants. The content is thus pre-mixed for the purpose and high-altitude work can be carried out with precision from ground level. The problem remains that different tasks require different agents/preparations and thus several vessels. The risk of spillage and leakage is ever present and if a vessel fails, the environmental damage is done and the risk of personal injury. The engineering and manufacturing industries are also facing new environmental requirements and new ways of thinking influence the environmental agenda.

If, for example, you can replace the barrels of emulsion fluids with tablets, the benefit is clear as financial savings are made. The development of tablets, concentrates, ampoules and powders for all possible uses and dissolution in liquids is progressing, but the problem of dissolution in plastic vessels or similar containers thus remains. Currently, the saving of any remaining tablet for further dissolution utilises plastic containers.

Furthermore, there are tablets and powders for purification and improvement of water, for example, lime in acidification, and tablets for decalcification, activated carbon etc. However, the problem remains with stagnant water such as a lake, as the lime tends to settle on the bottom like a cake if it is not mixed mechanically or with flowing water,

This means treatment plants that are cumbersome to transport to the current location, and if you use activated carbon, the liquid must flow through the charcoal to be purified.

We are now used to hard-packed products and concentrates for dissolution and dilution, not least thanks to the food industry (everything from candy lollipops to put in the mouth to tablets for the dishwasher) which has enabled a behavioural change to opt out of ready-mixed products delivered in plastic containers and switch to better environmental choices in tablet form, concentrates and other products that can be dissolve in liquid.

### PURPOSE OF THE INVENTION

The purpose of this invention is to provide a mixer in which tablets and granulated products, including concentrates and powders, can be dissolved with water or other liquids in a controlled and simple manner, whereby the invention solves the problems mentioned above. This is good for the environment and the economy and simplifies numerous tasks for consumers, professionals, and industry. This invention should be highly portable and can involve the cleaning of various solid objects such as fertilizing plants and garden, washing solar panels, vehicles, house facades, roofs as well as purification and descaling of water. The development of tablets and other products, ampoules etc is not limited to any one chore, therefore the market possibilities for this amazing invention reach far beyond the purposes discussed above. The mixer can also advantageously be attached to a belt holster around the waist and connected to a water hose, pump or water hydrant, as well as mounted in a fixed position.

### SUMMARY OF THE INVENTION

The above and other purposes are achieved by creating the mixer in accordance with the attached patent claims. Suitable embodiments of the invention are shown in the attached figures. The invention relates to a mixer for dissolving tablets, granules, powders or concentrate placed in a space inside the mixer, where the tablet may come into contact with the incoming liquid and thus dissolve and mix with the liquid. A suitable name can be mixer for dissolving tablets.

Before the task, a suitable tablet is placed in the mixer, then attach it to the appropriate tool or hose in the exit slot.

The mixer can be equipped with quick couplings both on input and output, for easier docking in mobile use. Upon activation of water supply or other liquids, the tablet will begin to dissolve, and the desired liquid will be mixed. As soon as the liquid supply is cut off and the liquid is drained from the mixer, the tablet does not encounter liquid, and the dissolution ends. You can thus save your tablet after the completion of the work and switch the tablet holder to undertake a different task with minimal fuss.

The invention consists of a metal body with an entrance hole for the inflow of water or other liquids, a knob for turning on and off the incoming liquid, as well as adjusting its pressure and flow. A float switch equipped with metal gauze, contains the tablets, and is closed with a lid. The outflow pipe with a threaded connection is suitable for a coupling for connecting the flushing hose and tools.

The outflow of liquid is visible in the outflow barrel (which is shaped like a sight glass) where the liquid has taken a cloudy or coloured appearance after the tablets dissolution and is thus an acknowledgement that dissolution of the tablet has started.

The invention is equipped with an indicator housing, partly designed as a sight glass. Inside the indicator housing, an indicator can appear, not dissimilar to a throttle needle. The indicator is at the other end and is connected to the float and affected by the position of the float which changes with the dissolution of the tablet and thus the position of the indicator showing tablet consumption.

In one version of the invention, the mixer is provided with an Archimedes screw located in the outflow barrel, the screw rotates at fluid flows and mixes the liquid further on its way out through the barrel.

In one version of the invention, the mixer's indicator is equipped with a convex-shaped plate or alternative shape, which provides increased hydrofoil force to the indicator through passing water flow, thus contributing to assisting force to the float that pushes the tablet against the water flow passing through the mixer and thus increases the tablet's dissolution.

In one version of the invention, it is equipped with a flow control and an indicator mounted on the knob, which facilitates the calculation of the fluid inflow and its pressure.

In one version of the invention, the mixer is equipped with adjustable bypass channels that can more quickly fill the float housing with water, which contains the tablet, which is in some cases designed like a lollipop with the stick acting as an indicator and visible in the indicator housing, which can also be equipped with an overflow channel for incoming liquid.

In one version of the invention is provided with a replaceable tablet container that holds the tablet and float, designed to fit in the float housing with or without an indicator stick. An associated plug facilitates loading and discharging of the tablet container.

In one version of the invention, the tablet container indicator is equipped with an additional buoyancy body placed in the indicator housing to provide extra lifting force for faster drying of the float housing, tablet container and its tablet. Draining of the float housing is done with the water turned off, by turning the invention upside down with its float housing pointing upwards and thus the tablet becomes dry.

In some versions of the invention, it is provided with filters for purifying liquids, dirty and polluted water.

### BRIEF DESCRIPTION OF THE DRAWINGS.

The invention will now be described in more detail with the help of examples of different versions, referring to the attached figures:

FIG. 1 shows an exploded view of the mixer as seen from the side according to an alternative first version of the invention.

FIG. 2 Displays an exploded view of the replaceable tablet container.

FIG. 3 Displays an exploded view of the “lollipop” consisting of tablet and indicator stick.

FIG. 4 Shows an exploded view of the cross section of the mixer in a second version of the invention.

FIG. 5 Shows an exploded view of the mixer in yet another alternative version of the invention.

### DESCRIPTION OF THE INVENTION

The application of the invention is as a mixer for dissolving tablets and other hard-packed granules, as well as powders and concentrates that are dissolvable in liquids and activated carbon and the like for the purification of liquids and contaminated water. The invention consists of a tube-like metal body 1 with entrance holes for liquid equipped with throttle valve 2 with threaded connection 3 for quick couplings. Incoming fluid flow shown by arrows is regulated via a ball valve with control lever/knob 4 and hand with flow control bezel for fluid control 5.

Body 1 is composed with a float housing 6 that contains the tablet 11, also fitted with an opening cap 7. Indicator housing 8 therein indicator 9 is visible and its position is affected by float 10 which rises with the help of incoming liquid and pushes tablet 11 up against a coarse mesh 12 and the dissolved tablet turns into a cloudy coloured liquid that passes the fine gauze mesh 13 and becomes visible in the sight glass barrel 14 accommodating an Archimedes screw 15 driven by the water flow and its pressure which also gives lift to indicator 9 via its convex-shaped hydro force plate 16.

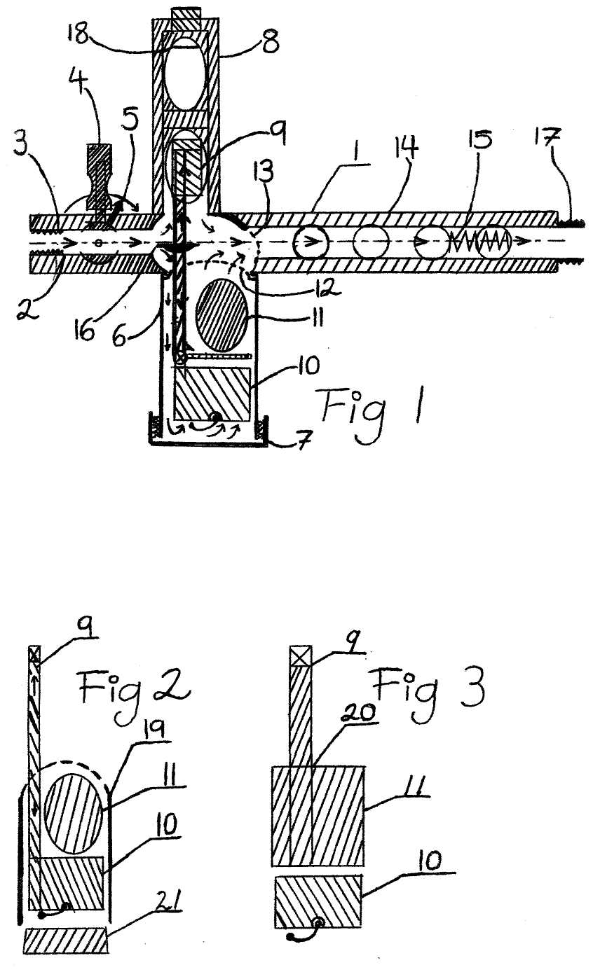

The premixed liquid passes through a quick coupling threaded onto the mouth 17 where tools and hoses can be connected for further transport of the liquid towards its target. In an alternative version of the invention shown in FIG. 1, an extra buoyancy body 18 is placed in indicator housing 8 in order to provide extra buoyancy to indicator 9 that lifts the float 10 up when draining the float housing 6, which is done by turning the invention upside down with its float housing 6 pointing upwards.

FIG. 2 shows an exploded view of float housing 6 and the tablet container 19 during operation, holding one tablet 11 and the float 10. As shown in FIG. 2, it is equipped with an indicator 9 partially visible in indicator housing 8, as well as a plug 21 that facilitates loading and discharging.

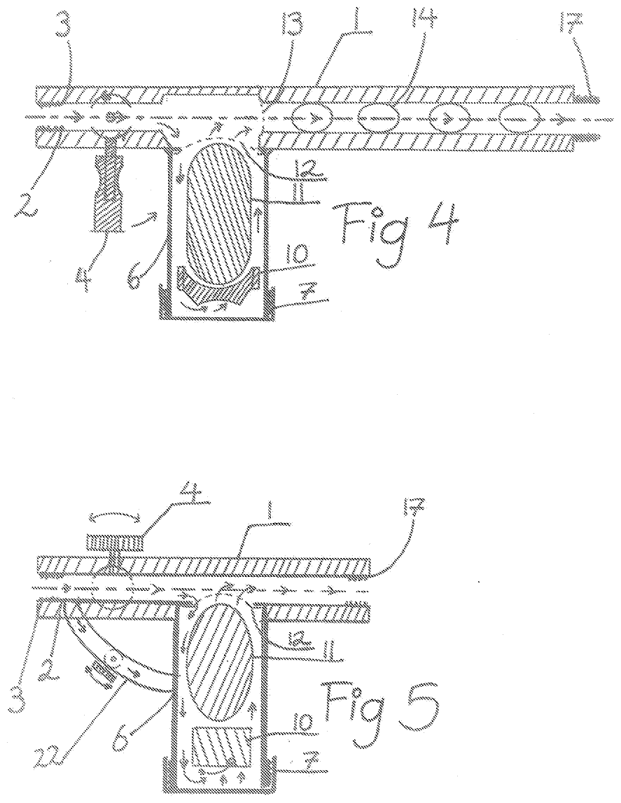

FIG. 3 shows an exploded view of the “lollipop” 20 consisting of a tablet 11 fitted with an embedded indicator 9. The “lollipop” is sized to fit and move smoothly within the float house 6 together with the float 10. As shown in FIG. 3, it is equipped with an indicator 9 visible and operating in the indicator house 8.

FIG. 4 shows an exploded view of the mixer in a second version of the present invention, which is similarly designed, shown here without indicator housing 8.

FIG. 5 shows an exploded view of the mixer in yet another alternative version of the invention. The invention is here equipped with a fluid-adjustable overflow channel 22, whereby incoming fluid can reach float housing 6.

A similar adjustable overflow channel 22 can also supply indicator housing 8 shown in FIG. 1 with liquid. Of course, the adjustable overflow channels 22 can also be used for draining fluid.

The invention is not limited to the versions shown and different combinations and locations of constituent details are conceivable, as well as sizes and materials. Also, preparations, chemicals and other hard packed, tablets, ampoules, liquid pads, seeds that can be placed in the mixer and mixed/dissolved with water and other liquids, or transported with the help of water to the chosen place, eg seeds and plant preparations. Also, various preparations for purifying or improving water and liquids, such as lime or activated carbon. which is mixed/purified and passes through the invention.

Likewise, the examples shown in the figures and the described can be varied between each other and can appear in one or more different positions. Such and other variations shall not be regarded as deviations from the scope of the present invention, as professionals in parts or the whole field understand. As well as not showing or illustrating details would be missing such as quick couplings, hoses, tools and utensils that are obvious to be included for a professional person in the field. The invention is of course not limited to what is described in the text and in the figures illustrated.

Modifications are possible, as regards the nature of the various features, or through the use of equivalent technology, without detracting from the scope of protection of the invention as defined in the patent claims.

1. A mixer, which comprises control lever/knob, throttle valve,cap,plug and machined surfaces including thread connection (3) and mouth (17), fine grid mesh (13) through which liquid can flow, characterised by a float operating in a float housing holding a tablet which dissolves with incoming liquid which flows through a body and becomes visible in a sight glass pipe.

2. The mixer according to claim 1, characterised by the float lifting the tablet towards a coarse mesh, the size of the tablet is shown by an indicator visible in an indicator housing.

3. The mixer according to claim 1, characterised by the fact that the indicator is connected to the float and thus positionally affected by the size of the tablet and the pressure from the float.

4. The mixer according to claim 3, characterised by a tablet container in which the tablet and the float are placed, which fits in the float housing and is charged by means of a plug.

5. The mixer according to claim 4 is characterised by a club which fits in the float housing together with the float.

6. The mixer according to claim 5 is characterised by the fact that the indicator is equipped with a convex-shaped hydro force plate.

7. The mixer according to claim 6 is characterised by an overflow channel which can supply the float housing and the indicator housing with liquid.

8. The mixer according to claim 7 is characterised by an additional buoyancy operating inside the indicator housing.

9. The mixer according to claim 8 is characterised by an Archimedes screw operated in the sight glass barrel.

10. The mixer according to claim 5 is characterised by the club whose indicator releases at the dissolution of the tablet and floats up into the indicator housing.

11. The mixer according to claims 2, characterised by a tablet container in which the tablet and the float are placed, which fits in the float housing and is charged by means of a plug.

12. The mixer according to claim 11 is characterised by a club which fits in the float housing together with the float.

13. The mixer according to any of claim 12 is characterised by the club whose indicator releases at the dissolution of the tablet and floats up into the indicator housing.

14. The mixer according to any of claim 6 is characterised by the club whose indicator releases at the dissolution of the tablet and floats up into the indicator housing.

15. The mixer according to any of claim 7 is characterised by the club whose indicator releases at the dissolution of the tablet and floats up into the indicator housing.

16. The mixer according to any of claim 8 is characterised by the club whose indicator releases at the dissolution of the tablet and floats up into the indicator housing.

17. The mixer according to any of claim 9 is characterised by the club whose indicator releases at the dissolution of the tablet and floats up into the indicator housing.
